(19) United States
(12) Patent Application Publication
(10) Pub. No.: US 2009/0157476 A1
(43) Pub. Date: Jun. 18, 2009

(54) MARKETING CAMPAIGN MANAGEMENT

(75) Inventors: Ibrahim M. Itani, Irving, TX (US); Farrukh Pulak, Irving, TX (US); Venugopal Jagannathan, Irving, TX (US)

Correspondence Address: VERIZON;PATENT MANAGEMENT GROUP, 1320 North Court House Road, 9th Floor, ARLINGTON, VA, 22201-2909, US

(73) Assignee: Verizon Data Services Inc., Temple Terrace, FL (US)

(21) Appl. No.: 11/959,131

(22) Filed: Dec. 18, 2007

(51) Int. Cl. G06Q 10/00

(52) U.S. Cl. 705/10

(57) ABSTRACT

A device receives one or more of customer data, customer models, or customer reports, calculates scored information based on the one or more of the customer data, customer models, or customer reports, and generates marketing campaign information for a product or a service based on the scored information and the one or more of the customer data, customer models, or customer reports. The device also generates a customer list based on the marketing campaign information and the one or more of the customer data, customer models, or customer reports, and conveys the marketing campaign information to one or more customers on the customer list.

### BACKGROUND

A marketing list is a collection of names, entity names, addresses, and other information associated with multiple recipients (e.g., customers or potential customers) used by an organization to send information associated with a product or service to the multiple recipients. Creation or generation of such a marketing list may be referred to as marketing list generation. Marketing list generation (e.g., for existing customers or potential customers of a product or service) is still very much a manual process involving interactions among multiple employees and/or groups of employees. Marketing list generation is also a time-consuming process. For example, it may take a couple of days to generate one marketing list (e.g., for a single product or a single service). Currently, third party software may aid the manual process of marketing list generation. However, such third party software is cumbersome, time consuming, and only provides a piecemeal solution to marketing list generation.

### BRIEF DESCRIPTION OF THE DRAWINGS

FIG. 1 is an exemplary diagram of a network in which systems and methods described herein may be implemented;

FIG. 2 illustrates exemplary components of a user device, a campaign management server, and/or a customer database server of the network depicted in FIG. 1;

FIG. 3 depicts exemplary interactions between the user device, the campaign management server, and the customer database server of the network illustrated in FIG. 1;

FIG. 4 depicts exemplary components of the campaign management server of the network illustrated in FIG. 1;

FIG. 5 illustrates exemplary components of the customer database server of the network illustrated in FIG. 1;

FIGS. 6-8 depict exemplary user interfaces capable of being provided by the campaign management server of the network illustrated in FIG. 1; and

FIGS. 9-12 depict a flow chart of an exemplary process according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may include systems and/or methods that provide an end-to-end campaign management and marketing resource and reporting application (hereinafter referred to as “campaign management application”) for automatically managing, generating, saving, and/or executing a marketing campaign and/or a customer list for one or more products and/or one or more services. For example, in one implementation, the campaign management application may receive customer data, customer models, and/or customer reports, and may calculate scored information based on the received information. The campaign management application may generate product and/or service campaign information based on the scored information, and may generate a customer marketing list based on the campaign information and the received information. The campaign information may be conveyed by the campaign management application to customers on the customer list, and feedback may be received by the campaign management application from the customers about the campaign information. The campaign management application may update the customer data, customer models, and/or customer reports based on the received feedback.

A “product,” as the term is used herein, is to be broadly interpreted to include any thing that may be marketed or sold as a commodity or a good. For example, in one implementation, a product may include a device, such as a radiotelephone, a personal communications system (PCS) terminal, a personal digital assistant (PDA), a laptop, a personal computer, other types of computation or communication devices, etc.

A “service,” as the term is used herein, is to be broadly interpreted to include any act or variety of work done for others (e.g., for compensation). For example, in one implementation, a service may include telecommunication services, such as telephone services, Internet services, network services, radio services, television services, video services, etc.

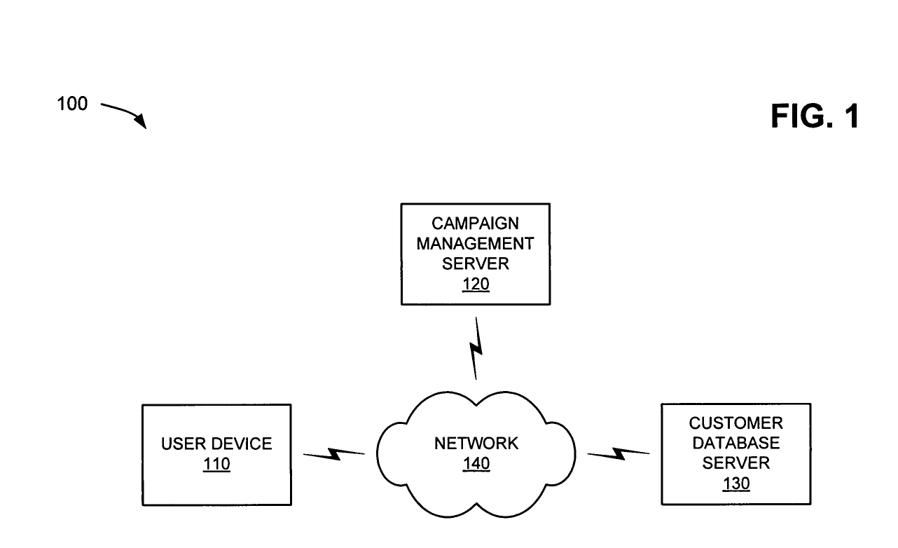

FIG. 1 is an exemplary diagram of a network 100 in which systems and methods described herein may be implemented. As illustrated, network 100 may include a user device 110, a campaign management server 120, and/or a customer database server 130 interconnected by a network 140. User device 110, campaign management server 120, and/or customer database server 130 may connect to network 140 via wired and/or wireless connections. A single user device, campaign management server, customer database server, and network have been illustrated in FIG. 1 for simplicity. In practice, there may be more or less user devices, campaign management servers, customer database servers, and/or networks. Also, in some instances, one or more of user device 110, campaign management server 120, and/or customer database server 130 may perform one or more functions described as being performed by another one or more of user device 110, campaign management server 120, and/or customer database server 130.

User device 110 may include a radiotelephone, a PCS terminal (e.g., that may combine a cellular radiotelephone with data processing and data communications capabilities), a personal digital assistant (PDA) (e.g., that can include a radiotelephone, a pager, Internet/intranet access, etc.), a laptop, a personal computer, an outbound calling module or terminal, an outbound email module, a device capable of auto dialing a telephone number, or other types of computation or communication devices, threads or processes running on these devices, and/or objects executable by these devices. In one implementation, user device 110 may include any device that is capable of accessing a software application or a web-based application (e.g., provided by campaign management server 120) that enables a user (e.g., a marketing manager, a produce manager, a service manager, etc.) of user device 110 to manage and generate a marketing campaign and/or a customer list for one or more products and/or one or more services. In another implementation, user device 110 may include any device (e.g., an outbound calling module, an outbound email module, direct mail generator, an auto dialer, etc.) that enables a user (e.g., a telemarketer, a marketing employee, etc.) to access a marketing campaign and/or a customer list so that the user may convey the marketing campaign to customers provided on the customer list.

Campaign management server 120 may include one or more server entities, or other types of computation or communication devices, that gather, process, search, and/or provide information in a manner described herein. In one implementation, campaign management server 120 may provide a software application or a web-based application (e.g., a campaign management application) that manages, generates, saves, and/or executes a marketing campaign and/or a customer list for one or more products and/or one or more services.

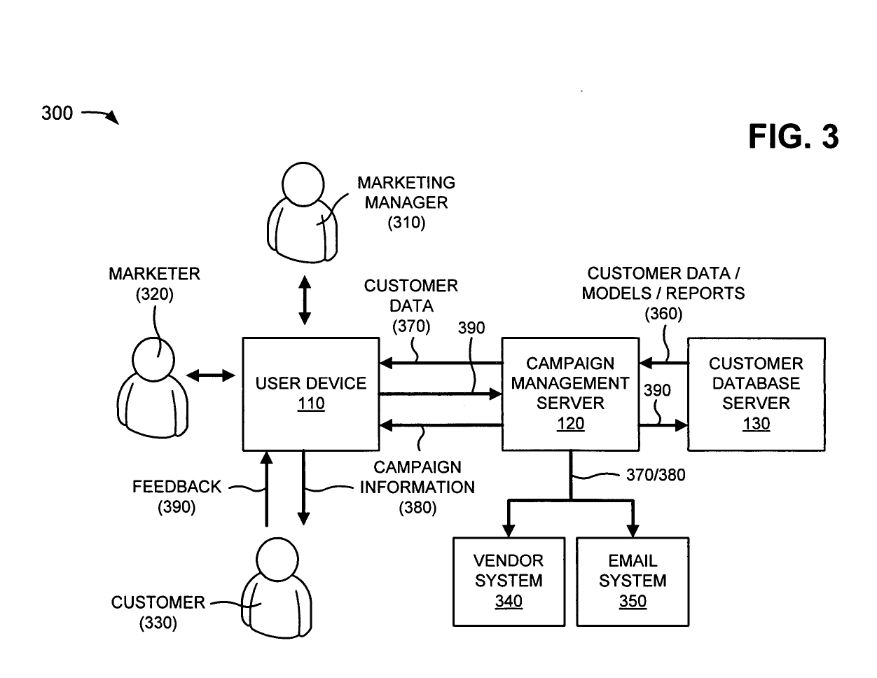

In one example, campaign management server 120 may receive (e.g., from user device 110, customer database server 120, devices not shown in FIG. 1, etc.) customer data, customer models, and/or customer reports, and may calculate scored information based on the received customer data, customer models, and/or customer reports. Campaign management server 120 may generate product and/or service campaign information based on the scored information, and may generate a customer marketing list based on the campaign information and the received information. The campaign information may be conveyed by campaign management server 120 to customers on the customer list (e.g., via user device 110, such as an outbound calling terminal), and feedback may be received by campaign management server 120 from the customers (e.g., via user device 110, such as an outbound calling terminal) about the campaign information. Campaign management server 120 may update the customer data, customer models, and/or customer reports based on the received feedback. Further details of campaign management server 120 are provided below in connection with FIGS. 3, 4, and 6-8.

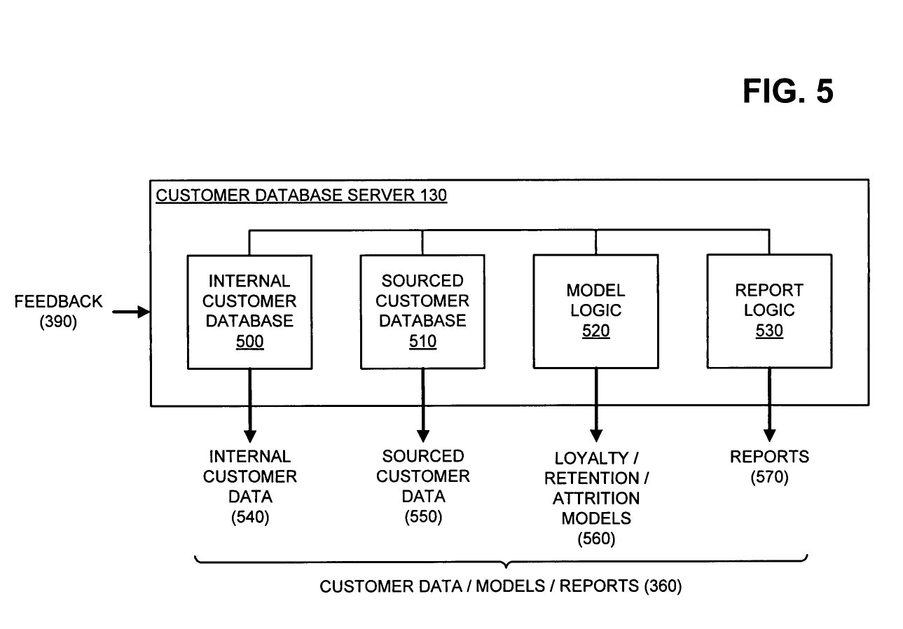

Customer database server 130 may include one or more server entities, or other types of computation or communication devices, that gather, process, search, and/or provide information in a manner described herein. In one implementation, customer database server 130 may include one or more devices that may receive and/or store internal customer data associated with existing and/or potential customers (e.g., customer data that may be internal to an organization offering products and/or services), sourced customer data associated with existing and/or potential customers (e.g., customer data that may received from a source external to an organization offering products and/or services), and/or customer models (e.g., customer loyalty models, customer retention models, customer attrition models, etc.). Customer database server 130 may provide the internal and/or sourced customer data, the customer models, and/or customer reports to campaign management server 120. Campaign management server 120 may use such information to manage and/or generate a marketing campaign and/or customer list. Further details of customer database server 130 are provided below in connection with FIGS. 3 and 5.

Network 140 may include a local area network (LAN), a wide area network (WAN), a metropolitan area network (MAN), an intranet, the Internet, a Public Land Mobile Network (PLMN), a telephone network, such as the Public Switched Telephone Network (PSTN) or a cellular telephone network, or a combination of networks.

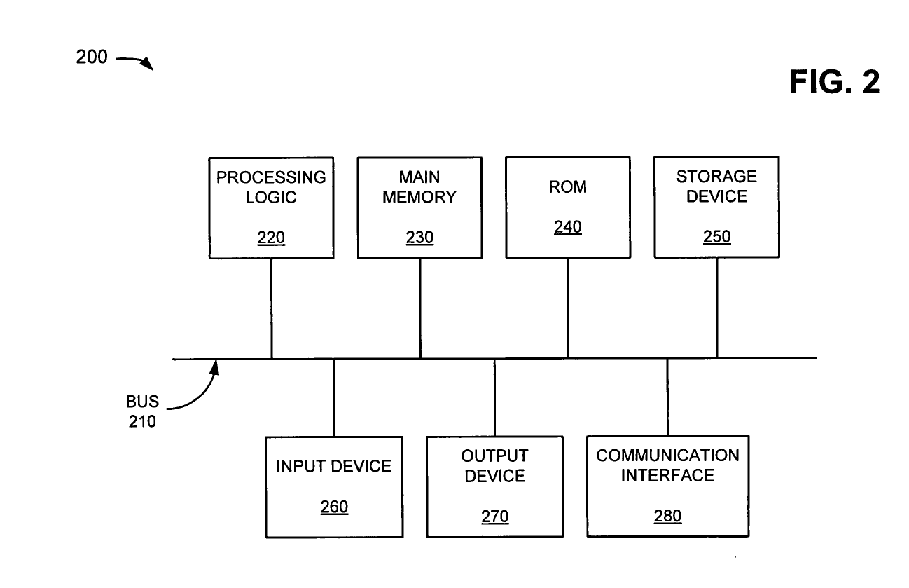

FIG. 2 is an exemplary diagram of a device 200 that may correspond to user device 110, campaign management server 120, and/or customer database server 130. As illustrated, device 200 may include a bus 210, processing logic 220, a main memory 230, a read-only memory (ROM) 240, a storage device 250, an input device 260, an output device 270, and/or a communication interface 280. Bus 210 may include a path that permits communication among the components of device 200.

Processing logic 220 may include a processor, microprocessor, or other type of processing logic that may interpret and execute instructions. Main memory 230 may include a random access memory (RAM) or another type of dynamic storage device that may store information and instructions for execution by processing logic 220. ROM 240 may include a ROM device or another type of static storage device that may store static information and/or instructions for use by processing logic 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network, such as network 140.

As described herein, device 200 may perform certain operations in response to processing logic 220 executing software instructions contained in a computer-readable medium, such as main memory 230. A computer-readable medium may be defined as a physical or logical memory device. The software instructions may be read into main memory 230 from another computer-readable medium, such as storage device 250, or from another device via communication interface 280. The software instructions contained in main memory 230 may cause processing logic 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

FIG. 3 depicts a portion 300 of network 100 (that includes user device 110, campaign management server 120, and customer database server 130), and exemplary interactions between user device 110, campaign management server 120, and customer database server 130. As illustrated, user device 110 may communicate with a marketing manager 310 (e.g., a user of user device 110), a marketer 320 (e.g., a user of user device 110), and/or a customer 330. As further illustrated in FIG. 3, campaign management server 120 may communicate with a vendor system 340 and/or an electronic mail (“email”) system 350.

Marketing manager 310 may include any person in an organization responsible for marketing one or more products and/or one or more services offered by the organization. In one implementation, for example, marketing manager 310 may include a marketing executive, a product manager, a service manager, etc. Marketing manager 310 may interact with campaign management server 120 (e.g., via user device 110) to manage, generate, save, and/or execute a marketing campaign and/or a customer list for one or more products and/or one or more services. For example, marketing manager 310 may input campaign properties (e.g., products to offer, services to offer, prices of products, prices of services, etc.) via user device 110.

Marketer 320 may include any person in an organization responsible for interacting with customers to market one or more products and/or one or more services offered by the organization. In one implementation, for example, marketer 320 may include a telemarketer, an email marketer, a direct mail marketer, etc. Marketer 320 may interact with campaign management server 120 (e.g., via user device 110) to access one or more marketing campaigns and/or customer lists for one or more products and/or one or more services. In such instances, user device 110 may operate as an outbound calling module, an outbound email module, a device capable of autodialing a telephone number, etc.

Customer 330 may include any person or business entity (e.g., a company) capable of purchasing one or more products and/or one or more services offered by an organization. In one implementation, for example, customer 330 may include a purchaser or a potential purchaser of telecommunications services, an existing customer or a potential customer of telecommunication services.

Vendor system 340 may include one or more server entities, or other types of computation or communication devices, that gather, process, search, and/or provide information in a manner described herein. In one implementation, vendor system 340 may include one or more devices that may receive campaign information (e.g., marketing campaigns for one or more products and/or one or more services) and/or customer lists, and may provide the campaign information to one or more customers (e.g., customer 330) provided on the customer lists. In one example, vendor system 340 may include one or more devices associated with third party telemarketers (e.g., telemarketers not affiliated with the organization that operates campaign management server 120). The third party telemarketers may access one or more marketing campaigns and/or customer lists for one or more products and/or one or more services (e.g., via vendor system 340), and may market (e.g., via telephones) the one or more products/services to one or more customers provided in the customer lists.

Email system 350 may include one or more server entities, or other types of computation or communication devices, that gather, process, search, and/or provide information in a manner described herein. In one implementation, email system 350 may include one or more devices that may receive campaign information (e.g., marketing campaigns for one or more products and/or one or more services) and/or customer lists, and may provide, via email, the campaign information to one or more customers (e.g., customer 330) provided on the customer lists. In one example, vendor system 340 may include one or more devices associated with a third party (e.g., a party not affiliated with the organization that operates campaign management server 120). The third party may access one or more marketing campaigns and/or customer lists for one or more products and/or one or more services (e.g., via email system 350), and may market (e.g., via email) the one or more products/services to one or more customers provided ion the customer lists.

As further shown in FIG. 3, customer database server 130 may provide internal and/or sourced customer data, customer models, and/or customer reports (e.g., customer data/models/reports 360) to campaign management server 120. Campaign management server 120 may use customer data/models/reports 360 to manage and/or generate customer data 370 (e.g., a customer list that may include names, addresses, telephone numbers, personal information, company information, etc. of customers) and/or campaign information 380 (e.g., marketing campaigns for one or more products and/or one or more services). Campaign management server 120 may provide customer data 370 and/or campaign information 380 to user device 110, vendor system 340, and/or email system 350. Vendor system 340 and email system 350 may distribute campaign information 380 to customers (e.g., contained in customer data 370), as described above.

User device 110 (e.g., with or without marketer 320) may convey campaign information 380 to customer 330, and may receive feedback 390 (e.g., customer interest in a product, service, etc.) about campaign information 380 from customer 330. In one example, user device 110 may email campaign information 380 to customer 330. In another example, user device 110 may be used by marketer 320 to contact customer 330 and to convey campaign information 380 to marketer 320 while marketer 320 verbally interacts with customer 330 (e.g., a telemarketing arrangement). User device 110 may provide feedback 390 to campaign management server 120, and campaign management server 120 may provide feedback 390 to customer database server 130. Campaign management server 120 may also update customer data/models/reports 360 based on the received feedback 390, and may provide the updated customer data/models/reports 360 to customer database server 130.

Although FIG. 3 shows exemplary components of network portion 300, in other implementations, network portion 300 may contain fewer, different, or additional components than depicted in FIG. 3. In still other implementations, one or more components of network portion 300 may perform one or more other tasks described as being performed by one or more other components of network portion 300.

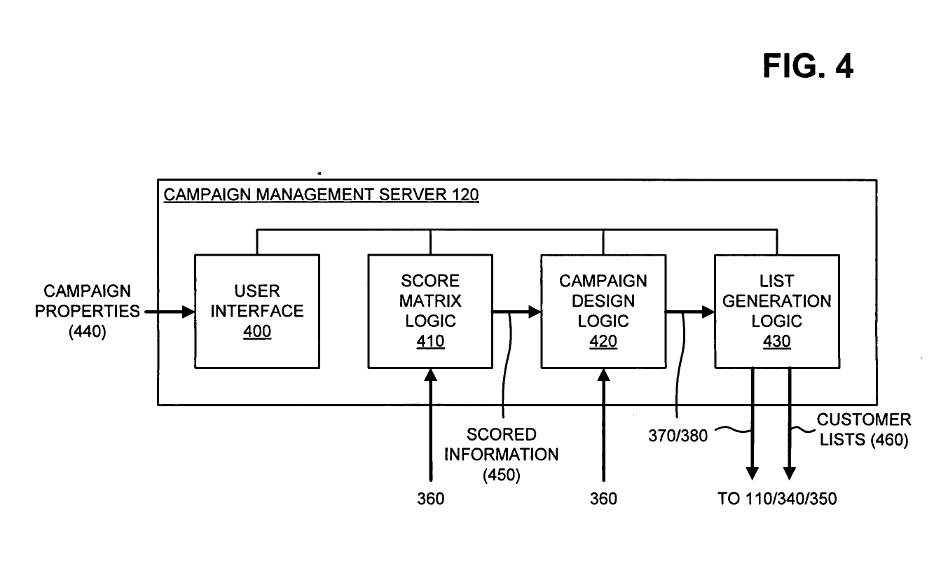

FIG. 4 depicts exemplary components of campaign management server 120. As illustrated, campaign management server 120 may include a user interface 400, score matrix logic 410, campaign design logic 420, and list generation logic 430.

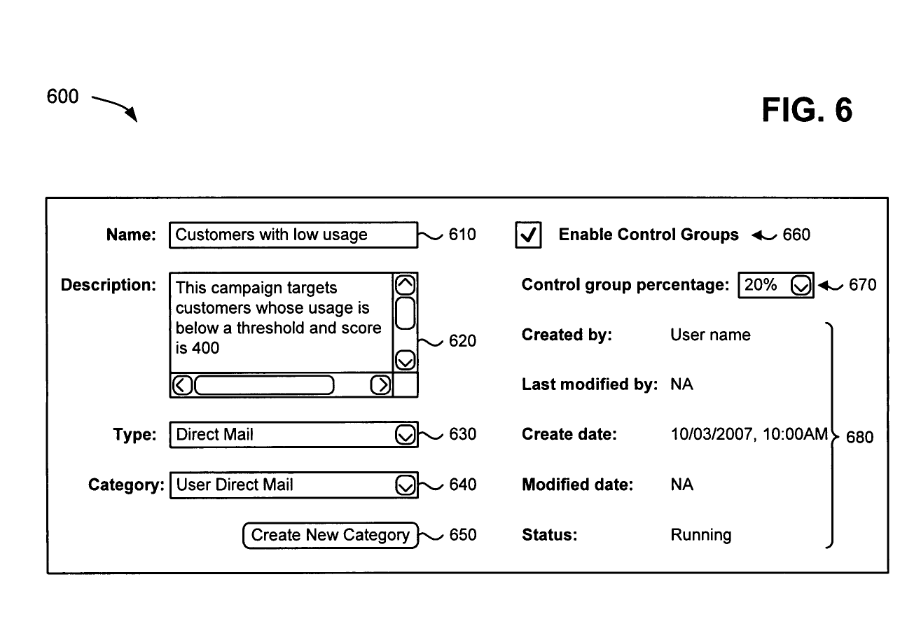

User interface 400 may include a graphical user interface (GUI) or a non-graphical user interface, such as a text-based interface. User interface 400 may provide information to users (e.g., marketing manager 310, marketer 320, etc.) via a customized interface (e.g., a proprietary interface) and/or other types of interfaces (e.g., a browser-based interface). User interface 400 may receive user inputs via one or more input devices (e.g., input device 260), may be user configurable (e.g., a user may change the size of user interface 400, information displayed in user interface 400, color schemes used by user interface 400, positions of text, images, icons, windows, etc., in user interface 400, etc.), and/or may not be user configurable. User interface 400 may be displayed to a user via one or more output devices (e.g., output device 270). In one implementation, as shown in FIG. 4, user interface 400 may receive campaign properties 440 (e.g., via inputs to user device 110 from marketing manager 310, marketer 320, etc.). Campaign properties 440 may include products to offer customers, services to offer customers, prices of products, prices of services, a mixture of products and services to offer customers, etc. Further details of campaign properties 440 are provided below in connection with FIG. 6.

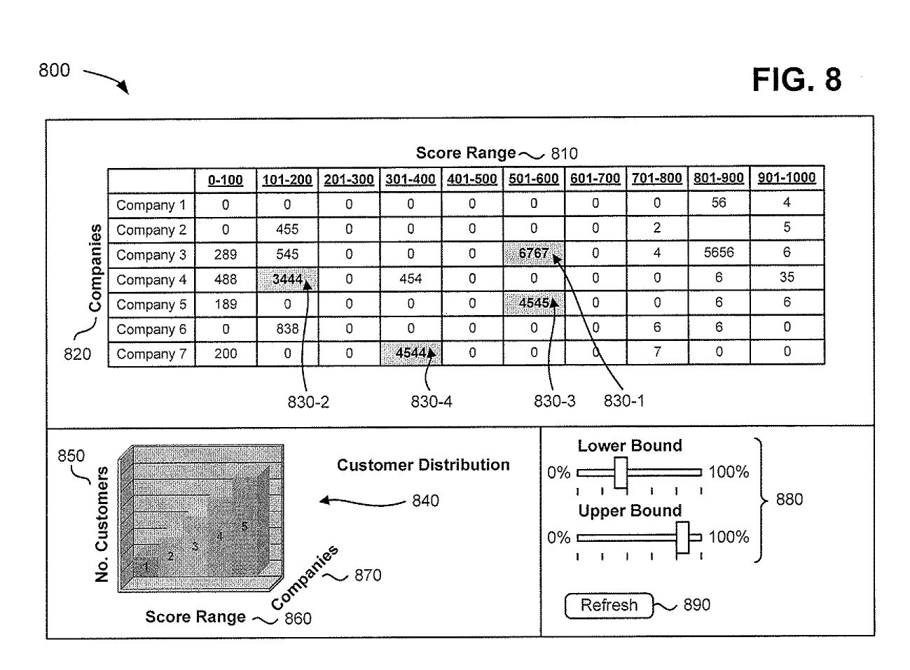

Score matrix logic 410 may include any hardware and/or software based logic (e.g., processing logic 220) that enables campaign management server 120 to generate a dynamic score matrix that may identify customer segments, product attributes, service attributes, customer churn information (e.g., propensity of customers to cease doing business with an organization in a given time period), etc. for an organization based on customer data/models/reports 360. In one example, the score matrix may be used to produce information (e.g., scored information 450) associated with customer segments, product attributes, service attributes, etc. that may be assigned values (e.g., based on a likelihood of a product and/or a service being sold to one or more customers). Scored information 450 may enable campaign management server 120 to identify groups of customers that are similar such that a similar product and/or service may appeal to all members of the group. Scored information 450 may also enable campaign management server 120 to target a customer segment (e.g., where customers may agree on what they value, scored information 450 may increase chances that a product and/or service may succeed, and may connect with the target customers). Score matrix logic 410 may provide scored information 450 to campaign design logic 360. Further details of the score matrix are provided below in connection with FIG. 8.

Campaign design logic 420 may include any hardware and/or software based logic (e.g., processing logic 220) that enables campaign management server 120 to design a marketing campaign for one products and/or services that may be tailored to one or more customers. In one implementation, campaign design logic 420 may receive customer data/models/reports 360, campaign properties 440, and/or scored information 450 and may design a marketing campaign based on customer data/models/reports 360, campaign properties 440, and/or scored information 450. The designed marketing campaign may include customer data 370 (e.g., a customer list that may include names, addresses, telephone numbers, personal information, company information, etc. of customers) and/or campaign information 380 (e.g., marketing campaigns for one or more products and/or one or more services). Customer data 370 and/or campaign information 380 may be provided to list generation logic 430.

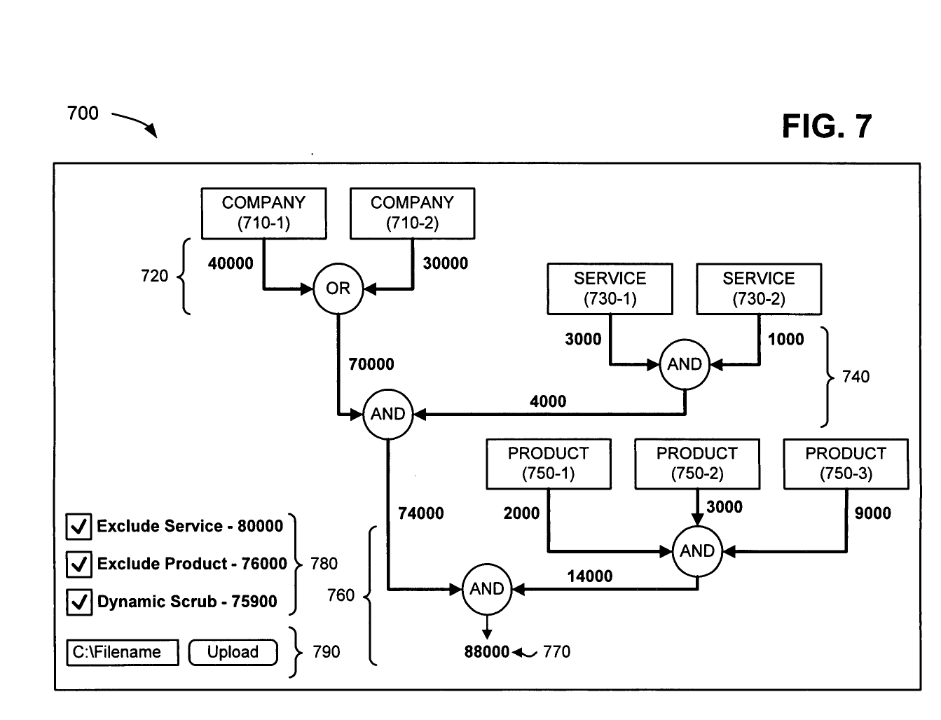

Campaign design logic 420 may enable a user (e.g., via user device 110) to create, save, and/or execute marketing campaigns directed to one or more products and/or one or more services that may be derived from a customer chum model (e.g., provided by customer database server 130). In one example, campaign design logic 420 may perform a “what-if” analysis on customer, product, service, etc. information to determine best target customer segments. Further details of designing a marketing campaign are provided below in connection with FIG. 7.

List generation logic 430 may include any hardware and/or software based logic (e.g., processing logic 220) that enables campaign management server 120 to generate one or more customer lists 460 based on customer data 370 and/or campaign information 380 (e.g., received from campaign design logic 420). Customer lists 460 may include lists of customers that may be targeted by campaign information 380 and may be associated with customer data 370. In one implementation, list generation logic 430 may provide customer data 370, campaign information 380, and/or customer lists 460 to user device 110, vendor system 340, and/or email system 350 for implementation, as described above in connection with FIG. 3.

Although FIG. 4 shows exemplary components of campaign management server 120, in other implementations, campaign management server 120 may contain fewer, different, or additional components than depicted in FIG. 4. In still other implementations, one or more components of campaign management server 120 may perform one or more other tasks described as being performed by one or more other components of campaign management server 120.

FIG. 5 illustrates exemplary components of customer database server 130. As illustrated, customer database server 130 may include an internal customer database 500, a sourced customer database 510, model logic 520, and report logic 530.

Internal customer database 500 may include a database capable of being provided in customer database server 130 (e.g., within storage device 250) and/or managed by customer database server 130. The information provided in internal customer database 500 may be provided by any device in network 100, and/or by any device provided in a network separate from network 100. Internal customer database 500 may include a variety of information, such as internal customer data 540 associated with existing and/or potential customers (e.g., customer data that may be internal to an organization offering products and/or services).

Sourced customer database 510 may include a database capable of being provided in customer database server 130 (e.g., within storage device 250) and/or managed by customer database server 130. The information provided in sourced customer database 510 may be provided by any device in network 100, and/or by any device provided in a network separate from network 100. Sourced customer database 510 may include a variety of information, such as sourced customer data 550 associated with existing and/or potential customers (e.g., customer data that may received from a source external to an organization offering products and/or services).

Model logic 520 may include any hardware and/or software based logic (e.g., processing logic 220) that enables customer database server 130 to provide one or more models associated with customers. In one implementation, model logic 520 may provide a customer loyalty model (e.g., a model that may provide an indication of customer loyalty to products and/or services), a customer retention model (e.g., a model that may provide an indication of repeat customers of products and/or services), and/or a customer attrition model (e.g., a model that may provide an indication of which customers may stop buying products and/or services, may score and rank customers based on their likelihood to chum, and may identify targeted retention efforts, etc.). Model logic 520 may output loyalty, retention, and/or attrition models 560 to campaign management server 120 and/or to report logic 530.

Report logic 530 may include any hardware and/or software based logic (e.g., processing logic 220) that enables customer database server 130 to provide one or more reports 570 associated with customers. In one implementation, report logic 530 may receive loyalty/retention/attrition models 560, and may generate reports 570 based on models 560. Reports 570 may include an identification of most valuable customers and how to treat them (e.g., may identify how much to spend to retain the most valuable customers, effective methods for retaining such customers, etc.), an identification of opportunities and tactics to increase customer retention (e.g., may identify customer retention rates, whether desirable customers are being retained, at risk customers, etc.), and an identification of “up-sell” (e.g., a marketing term for the practice of suggesting higher priced products or services to a customer who is considering a purchase) and “cross-sell” (e.g., a marketing term for the practice of suggesting related products or services to a customer who is considering buying something) opportunities (e.g., may identify which products represent the best opportunities for cross-sell). Report logic 530 may output reports 570 to customer management server 120.

As further shown in FIG. 5, customer database server 130 may receive customer feedback 390. Customer database server 130 may utilize feedback 390 to update information contained in internal customer database 500 and/or sourced customer database 510, to update models 560, and/or to update reports 570. Internal customer data 540, sourced customer data 550, models 560, and reports 570 may be collectively referred to as customer data/models/reports 360.

Although FIG. 5 shows exemplary components of customer database server 130, in other implementations, customer database server 130 may contain fewer, different, or additional components than depicted in FIG. 5. In still other implementations, one or more components of customer database server 130 may perform one or more other tasks described as being performed by one or more other components of customer database server 130.

FIGS. 6-8 depict exemplary user interfaces 600-800 that may be provided by campaign management server 120 (e.g., via user interface 400). In one implementation, user interfaces 600-800 may display a variety of information capable of being provided by the campaign management application of campaign management server 120 (e.g., to user device 110). In one example, the variety of information may be generated and provided (e.g., via email, directly, via a download, etc.) to a user of user device 110 with a single selection mechanism (e.g., a single click of a mouse).

If a user executes the campaign management application (e.g., via user device 110), a user interface 600 (e.g., campaign properties), as shown in FIG. 6, may be displayed to the user. As illustrated, user interface 600 may include a variety of information associated with campaign properties. In one implementation, user interface 600 may include a name input field 610, a description input field 620, a type menu 630, a category menu 640, a create new category selection mechanism 650, an enable control groups selection mechanism 660, a control group percentage menu 670, and/or an information section 680.

Name input field 610 may include a field that enables a user to input a name associated with campaign properties defined in user interface 600. For example, name input field 610 may include an input field (e.g., for typing a name, such as “Customers with low usage”), a drop-down menu (e.g., for selecting a name from a list of names), and/or other types of input mechanisms.

Description input field 620 may include a field that enables a user to input descriptive information associated with campaign properties defined in user interface 600. For example, description input field 620 may include an input field (e.g., for typing descriptive information, such as “This campaign targets customers whose usage is below a threshold and score is 400”), a drop-down menu (e.g., for selecting descriptive information from a list of information), and/or other types of input mechanisms.

Type menu 630 may include may include a menu of types of marketing tactics (e.g., telemarketing, direct mail, email, etc.) associated with a marketing campaign of one or more products and/or services. One or more types of marketing tactics listed in type menu 630 may be selected by a user (e.g., via user device 110), and the campaign management application may associate the selected marketing tactic(s) with the campaign properties defined in user interface 600. In one implementation, as shown in FIG. 6, a user may select a “Direct Mail” marketing tactic from type menu 630.

Category menu 640 may include may include a menu of categories associated with the marketing tactic type selected from type menu 630. One or more categories associated with the marketing tactic type selected from type menu 630 may be selected by a user (e.g., via user device 110), and the campaign management application may associate the selected category(ies) with the campaign properties defined in user interface 600. In one implementation, as shown in FIG. 6, a user may select a “User Direct Mail” category from category menu 640.

Create new category selection mechanism 650 may include a mechanism (e.g., a button, an icon, a link, etc.) that, if selected (e.g., with a selection mechanism, such as a mouse), may enable the user to create a new category associated with the marketing tactic type selected from type menu 630. For example, the user may create a new “mass mailing” category that may define a mass mailing of a newly offered product and/or service to all customers.

Enable control groups selection mechanism 660, if selected (e.g., with a selection mechanism, such as a mouse), may enable campaign management server 120 to define a control group (e.g., a group of customers that may be used as a test group) for a marketing campaign of one or more products and/or services (e.g., as defined by the campaign properties set forth in user interface 600). For example, if a control group is enabled for the marketing campaign set forth in FIG. 6, the control group may receive the marketing campaign information prior to other customers (e.g., in order test the effectiveness of the marketing campaign).

Control group percentage menu 670 may include may include a menu of percentages associated with a control group (e.g., if enable control groups selection mechanism 660 is selected by the user). One or more percentages listed in control group percentage menu 670 may be selected by a user (e.g., via user device 110), and the campaign management application may associate the selected percentage(s) with the campaign properties defined in user interface 600. In one implementation, as shown in FIG. 6, a user may select “20%” from control group percentage menu 670.

Information section 680 may include a variety of information associated with a marketing campaign of one or more products and/or services (e.g., as defined by the campaign properties set forth in user interface 600). For example, information section 680 may include a “created by” portion (e.g., identifying who created the campaign properties, such as “User name”), a “last modified by” portion (e.g., identifying who last modified the campaign properties, such as “NA” or not applicable), a “create date” portion (e.g., a creation date of the campaign properties, such as “10/03/2007, 0:00 AM”), a “modified date” portion (e.g., a date the campaign properties were modified, such as “NA”), and a “status” portion (e.g., identifying an operational state of the campaign properties, such as “Running”).

Although FIG. 6 shows exemplary elements of user interface 600, in other implementations, user interface 600 may contain fewer, different, or additional elements than depicted in FIG. 6.

If a user executes the campaign management application (e.g., via user device 110), a user interface 700 (e.g., a campaign flow), as shown in FIG. 7, may be displayed to the user. As illustrated, user interface 700 may be generated based on the campaign properties, and may include a variety of information associated with a campaign flow. In one implementation, user interface 700 may include company blocks 710-1 and 710-2, a first mathematical operation section 720, service blocks 730-1 and 730-2, a second mathematical operation section 740, product blocks 750-1, 750-2, and 750-3, a third mathematical operation section 760, a campaign score 770, score filtering mechanisms 780, and a campaign upload mechanism 790.

Company blocks 710-1 and 710-2 may provide a visual (e.g., textual, graphical, textual and graphical, etc.) indication of one or more customers (e.g., companies) associated with a marketing campaign defined by the campaign management application. For example, company blocks 710-1 and 710-2 may include names of companies (e.g., telecommunication companies, cable companies, etc.) associated with the marketing campaign.

First mathematical operation section 720 may include a value (or count) associated with company block 710-1, a value associated with company block 710-2, and a mathematical operator to be used with the company block values. For example, company block 710-1 may have a value of “40000” associated with it, company block 710-2 may have a value of “30000” associated with it, and a mathematical “OR” operation may be applied to the values to generate a value of “70000.” The values associated with company blocks 710-1 and 710-2 may be assigned by the campaign management application and may provide indications of importance, value, etc. of the companies provided in company blocks 710-1 and 710-2.

Service blocks 730-1 and 730-2 may provide a visual (e.g., textual, graphical, textual and graphical, etc.) indication of one or more services associated with a marketing campaign defined by the campaign management application. For example, service blocks 730-1 and 730-2 may include names of services (e.g., telecommunication services, cable services, etc.) associated with the marketing campaign.

Second mathematical operation section 740 may include a value associated with service block 730-1, a value associated with service block 730-2, a mathematical operator to be used with the service block values, and a mathematical operator to combine the company block values and the service block values. For example, service block 730-1 may have a value of “3000” associated with it, service block 730-2 may have a value of “1000” associated with it, and a mathematical “AND” operation may be applied to the values to generate a value of “4000.” Another mathematical “AND” operation may be applied to the “4000” value and the “70000” value generated by first mathematical operation section 720 to generate a value of “74000.” The values associated with service blocks 730-1 and 730-2 may be assigned by the campaign management application and may provide indications of importance, value, etc. of the services provided in service blocks 730-1 and 730-2.

Product blocks 750-1, 750-2, and 750-3 may provide a visual (e.g., textual, graphical, textual and graphical, etc.) indication of one or more products associated with a marketing campaign defined by the campaign management application. For example, product blocks 750-1, 750-2, and 750-3 may include names of products (e.g., telecommunication products, cable products, etc.) associated with the marketing campaign.

Third mathematical operation section 760 may include a value associated with product block 750-1, a value associated with product block 750-2, a value associated with product block 750-3, a mathematical operator to be used with the product block values, and a mathematical operator to combine the company/service block values and the product block values. For example, product block 750-1 may have a value of “2000” associated with it, product block 750-2 may have a value of “3000” associated with it, product block 750-3 may have a value of “9000” associated with it, and a mathematical “AND” operation may be applied to the values to generate a value of “14000.” Another mathematical “AND” operation may be applied to the “14000” value and the “74000” value generated by first mathematical operation section 720 and second mathematical operation section 740 to generate campaign score 770 (e.g., a value of “88000”). The values associated with product blocks 750-1, 750-2, and 750-3 may be assigned by the campaign management application and may provide indications of importance, value, etc. of the products provided in product blocks 750-1, 750-2, and 750-3.

Campaign score 770 may provide a value for the marketing campaign defined by the campaign management application. Campaign score 770 may be included in a score matrix (e.g., provided by score matrix logic 410), as described below in connection with FIG. 8.

Score filtering mechanisms 780 may include selection mechanisms (e.g., checkboxes) that may be selected by a user (e.g., via user device 110). For example, score filtering mechanisms 780 may include an exclude service mechanism (e.g., which may exclude one or more service values from the calculation of campaign score 770), an exclude product mechanism (e.g., which may exclude one or more product values from the calculation of campaign score 770), and a dynamic scrub mechanism (e.g., which may filter campaign score 770 based on other factors, e.g., selected companies, services, products, etc.).

Campaign upload mechanism 790 may include a mechanism (e.g., an input field) that may be selected by a user (e.g., via user device 110). For example, campaign upload mechanism 790 may include a field for receiving input of a file name associated with the marketing campaign defined by the campaign management application, and an upload mechanism (e.g., a button) that, if selected, may enable information associated with the marketing campaign to be uploaded (e.g., to user device 110, customer database server 130, vendor system 340, and/or email system 350).

Although FIG. 7 shows exemplary elements of user interface 700, in other implementations, user interface 700 may contain fewer, different, or additional elements than depicted in FIG. 7.

If a user executes the campaign management application (e.g., via user device 110), a user interface 800 (e.g., a campaign score matrix), as shown in FIG. 8, may be displayed to the user. As illustrated, user interface 800 may be generated based on the campaign properties and/or the campaign flow, and may include a variety of campaign information. In one implementation, user interface 800 may include a score matrix (e.g., in an upper section) that includes a score range 810, companies 820, and highlighted entries 830-1, . . . , 830-4; a customer distribution 840 (e.g., in a lower left section) that includes a number of customers 850, a score range 860, and companies 870; and editing mechanisms (e.g., in a lower right section) that include bound selection mechanisms 880 and a refresh mechanism 890.

The score matrix may be generated (e.g., by score matrix logic 410) based on campaign scores 770 described above in connection with FIG. 7. Score range 810 of the score matrix may include one or more ranges of scores associated with the marketing campaign defined by the campaign management application. For example, score range 810 may include the following ranges of scores: “0-100,” “101-200,” “201-300,” “301-400,” “401-500,” “501-600,” “601-700,” “701-800,” “801-900,” and/or “901-1000.”

Companies 820 may include one or more companies (e.g., customers of the organization that generated the marketing campaign) associated with the marketing campaign defined by the campaign management application. For example, companies 820 may include “Company 1,” “Company 2,” “Company 3,” “Company 4,” “Company 5,” “Company 6,” and “Company 7.” Each of companies 820 may be associated with one or more entries for each range of scores provided in score range 810. For example, “Company 1” may include an entry of “56” for score range “801-900.” In one implementation, a higher entry value may indicate a higher effectiveness for the marketing campaign defined by the campaign management application. In other implementations, a lower entry value may indicate a higher effectiveness for the marketing campaign defined by the campaign management application.

Highlighted entries 830-1, . . . , 830-4 may include entries in the score matrix with the highest values (e.g., the highest effectiveness for the marketing campaign defined by the campaign management application). For example, highlighted entry 830-1 may include a value of “6767” (e.g., the highest value), highlighted entry 830-2 may include a value of “3444,” highlighted entry 830-3 may include a value of “4545,” and highlighted entry 830-4 may include a value of “4544.” Highlighted entries 830-1, . . . , 830-4 may be highlighted in a variety of ways, such as by shading, bolding, color, text size, etc.

Customer distribution 840 may be generated (e.g., by score matrix logic 410) based on the score matrix information. For example, customer distribution 840 may be generated based on score range 810 and companies 820, as well as number of customers 850. Customer distribution 840 may provide a three-dimensional bar graph that may highlight (e.g., based on height of the bars) which companies may be affected the most by the marketing campaign defined by the campaign management application. In one implementation, a higher bar may indicate a higher effectiveness for the marketing campaign defined by the campaign management application. In other implementations, a lower bar may indicate a higher effectiveness for the marketing campaign defined by the campaign management application.

Number of customers 850 may include a number of customers for companies defined by companies 820. For example, if a company is a telecommunication company, number of customers 850 may provide a value for a number of customers for the telecommunication company.

Score range 860 may include the same features described above in connection with score range 810. Companies 870 may include the same features described above in connection with companies 820.

Bound selection mechanisms 880 may include mechanisms (e.g., a sliding scale, a drop-down menu, etc.) that may be selected by a user (e.g., via user device 110). For example, bound selection mechanisms 880 may include a lower bound selection mechanism and an upper bound mechanism. The lower bound mechanism may provide a sliding scale (e.g., “0%” to “100%”) that may provide a lower boundary for entries of the score matrix that may be highlighted (e.g., highlighted entries 830-1, . . . , 830-4). The upper bound mechanism may provide a sliding scale (e.g., “0%” to “100%”) that may provide an upper boundary for entries of the score matrix that may be highlighted (e.g., highlighted entries 830-1, . . . , 830-4).

Refresh mechanism 890 may include a mechanism (e.g., a button, an icon, a link, etc.) that may be selected by a user (e.g., via user device 110). Refresh mechanism 890, if selected, may regenerate entries of the score matrix that may be highlighted (e.g., highlighted entries 830-1, . . . , 830-4) based on the lower and upper boundaries set by bound selection mechanisms 880.

Although FIG. 8 shows exemplary elements of user interface 800, in other implementations, user interface 800 may contain fewer, different, or additional elements than depicted in FIG. 8.

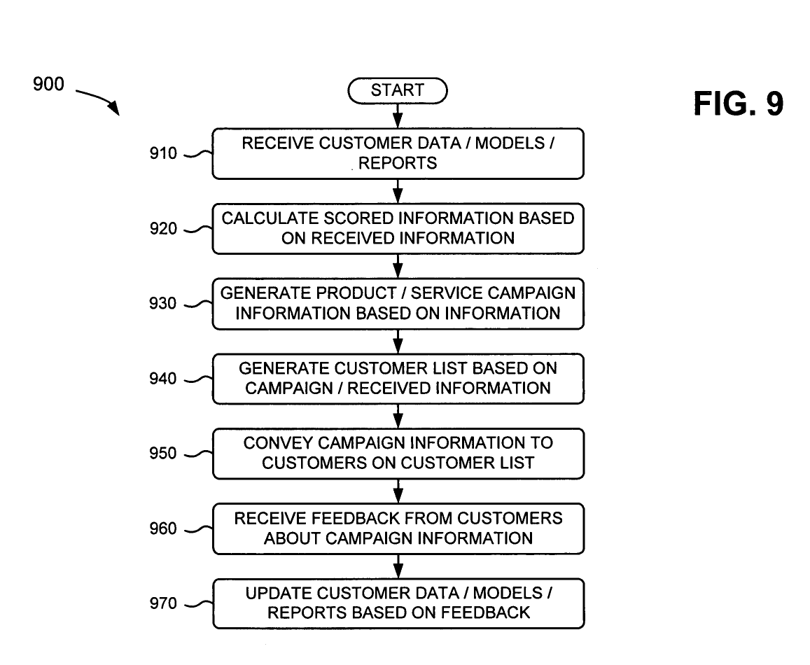

FIGS. 9-12 depict flow charts of an exemplary process 900 for automatically managing, generating, saving, and/or executing a marketing campaign and/or a customer list for one or more products and/or one or more services according to implementations described herein. In one implementation, process 900 may be performed by campaign management server 120. In another implementation, some or all of process 900 may be performed by another device or group of devices, including or excluding campaign management server 120.

As illustrated in FIG. 9, process 900 may begin with receipt of customer data, customer models, and/or customer reports (block 910), and calculating scored information based on one or more of the customer data, customer models, and/or customer reports (block 920). For example, in implementations described above in connection with FIGS. 3 and 4, campaign management server 120 may receive internal and/or sourced customer data, customer models, and/or customer reports (e.g., customer data/models/reports 360) from customer database server 130. Score matrix logic 410 of customer management server 120 may generate a dynamic score matrix that may identify customer segments, product attributes, service attributes, customer churn information (e.g., propensity of customers to cease doing business with an organization in a given time period), etc. for an organization based on customer data/models/reports 360. In one example, the score matrix may be used to produce scored information 450 associated with customer segments, product attributes, service attributes, etc. that may be assigned values (e.g., based on a likelihood of a product and/or a service being sold to one or more customers).

As further shown in FIG. 9, product and/or service campaign information may be generated based on the scored information and/or one or more of the customer data, customer models, and/or customer reports (block 930), and a customer list may be generated based on one or more of the customer data, customer models, and/or customer reports (block 940). For example, in implementations described above in connection with FIGS. 3 and 4, campaign management server 120 may use customer data/models/reports 360 to manage and/or generate customer data 370 (e.g., a customer list that may include names, addresses, telephone numbers, personal information, company information, etc. of customers) and/or campaign information 380 (e.g., marketing campaigns for one or more products and/or one or more services). Campaign design logic 420 of campaign management server 120 may receive customer data/models/reports 360, campaign properties 440, and/or scored information 450 and may design a marketing campaign based on customer data/models/reports 360, campaign properties 440, and/or scored information 450.

Returning to FIG. 9, the campaign information may be conveyed to one or more customers on the customer list (block 950), feedback may be received from the one or more customers about the campaign information (block 960), and one or more of the customer data, customer models, and/or customer reports may be updated based on the feedback (block 970). For example, in implementations described above in connection with FIG. 3, campaign management server 120 may provide customer data 370 and/or campaign information 380 to user device 110, vendor system 340, and/or email system 350. User device 110, vendor system 340, and email system 350 may be used to distribute campaign information 380 to customers (e.g., contained in customer data 370). User device 110 (e.g., with or without marketer 320) may receive feedback 390 about campaign information 380 from customer 330. User device 110 may provide feedback 390 to campaign management server 120, and campaign management server 120 may update customer data/models/reports 360 based on the received feedback 390, and may provide the updated customer data/models/reports 360 to customer database server 130.

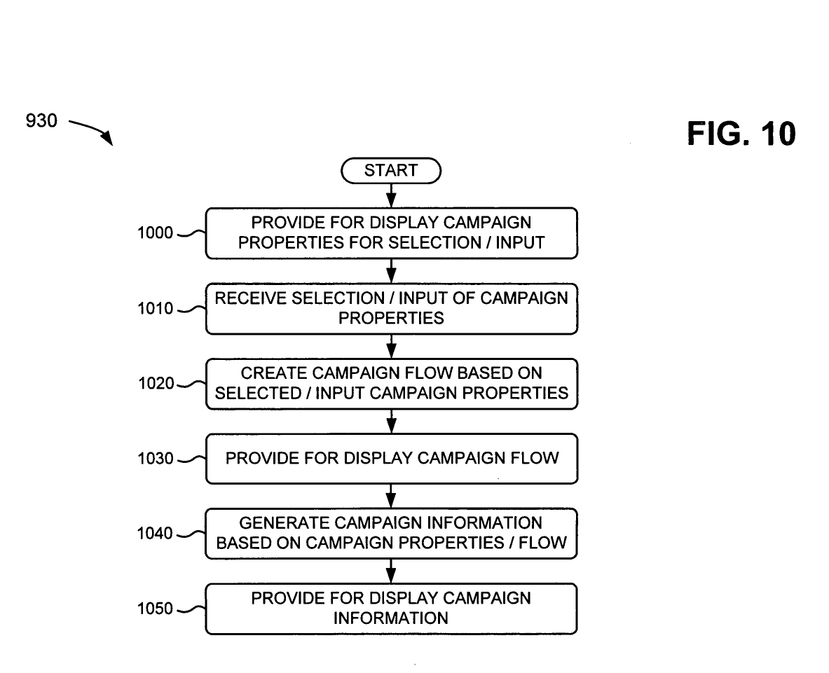

Process block 930 may include the process blocks illustrated in FIG. 10. As shown in FIG. 10, process block 930 may include providing for display of campaign properties for selection and/or input (block 1000), and receiving selection and/or input of the campaign properties (block 1010). For example, in one implementation described above in connection with FIG. 6, if a user executes the campaign management application, user interface 600 (e.g., campaign properties) may be displayed to the user. User interface 600 may include name input field 610 (e.g., a field that enables a user to input a name associated with the campaign properties), description input field 620 (e.g., a field that enables a user to input descriptive information associated with the campaign properties), type menu 630 (e.g., a menu of types of marketing tactics associated with a marketing campaign of one or more products and/or services that may be selected by a user), category menu 640 (e.g., a menu of categories associated with the marketing tactic type selected from type menu 630 that may be selected by a user), create new category selection mechanism 650 (e.g., a mechanism that may enable the user to create a new category associated with the marketing tactic type selected from type menu 630), enable control groups selection mechanism 660 (e.g., a selection mechanism that may enable a user to define a control group), control group percentage menu 670 (e.g., a menu of percentages associated with a control group), and/or information section 680 (e.g., a variety of information associated with a marketing campaign of one or more products and/or services).

As further shown in FIG. 10, a campaign flow may be created based on the selected and/or input campaign properties (block 1020), and the campaign flow may be provided for display (block 1030). For example, in one implementation described above in connection with FIG. 7, if a user executes the campaign management application, user interface 700 (e.g., a campaign flow) may be displayed to the user. User interface 700 may be generated based on the campaign properties, and may include company blocks 710-1 and 710-2 (e.g., companies associated with a marketing campaign defined by the campaign management application), first mathematical operation section 720, service blocks 730-1 and 730-2 (e.g., one or more services associated with a marketing campaign defined by the campaign management application), second mathematical operation section 740, product blocks 750-1, 750-2, and 750-3 (e.g., one or more products associated with a marketing campaign defined by the campaign management application), third mathematical operation section 760, campaign score 770 (e.g., a value for the marketing campaign defined by the campaign management application), score filtering mechanisms 780, and/or campaign upload mechanism 790.

Returning to FIG. 10, campaign information may be generated based on the campaign properties and/or the campaign flow (block 1040), and the campaign information may be provided for display (block 1050). For example, in one implementation described above in connection with FIG. 8, if a user executes the campaign management application, user interface 800 (e.g., a campaign score matrix) may be displayed to the user. User interface 800 may be generated based on the campaign properties and/or the campaign flow, and may include the score (e.g., generated by score matrix logic 410), score range 810 of the score matrix, companies 820 of the score matrix (e.g., customers of the organization that generated the marketing campaign), highlighted entries 830-1, . . . , 830-4 of the score matrix (e.g., entries in the score matrix with the highest values), customer distribution 840 (e.g., a three-dimensional bar graph that may highlight which companies may be affected the most by the marketing campaign defined by the campaign management application), number of customers 850 of customer distribution 840, score range 860 of customer distribution 840, bound selection mechanisms 880, and/or refresh mechanism 890.

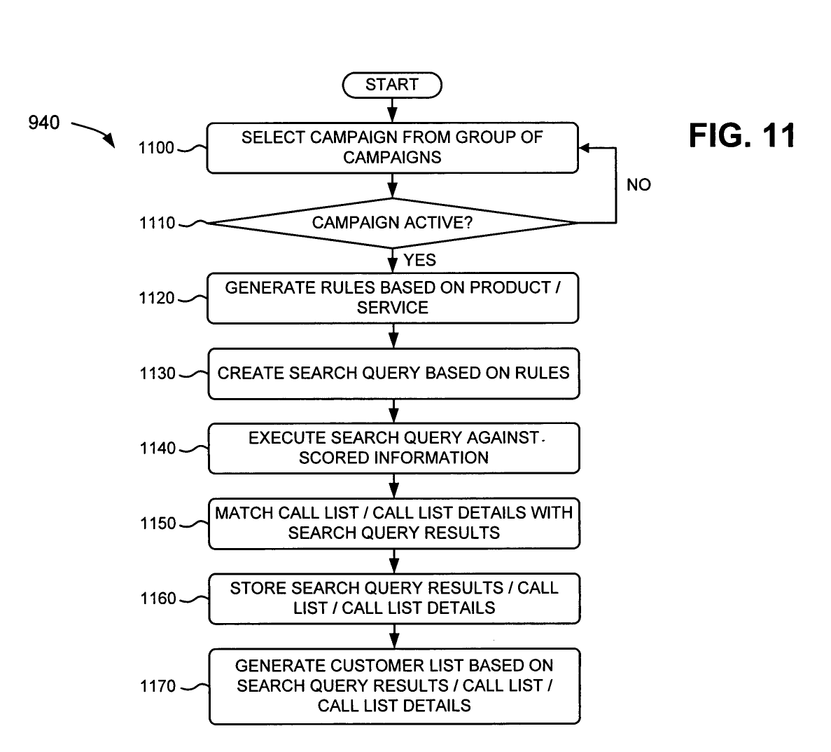

Process block 940 may include the process blocks illustrated in FIG. 11. As shown in FIG. 11, process block 940 may include selecting a campaign from a group of campaigns (block 1100), and determining if the campaign is active (block 1110). If the selected campaign is not active (block 1110—NO), process may return to block 1100. For example, in one implementation, customer management server 120 may select a campaign from a group of campaigns (e.g., contained in storage device 250) based on customer data/models/reports 360, campaign properties 440, and/or scored information 450, and may determine if the selected campaign is active (e.g., the products and/or services are available, etc.).

As further shown in FIG. 11, if the selected campaign is active (block 1110—YES), one or more rules may be generated based on a product and/or service associated with the selected campaign (block 1120), and a search query may created based on the one or more rules (block 1130). For example, in one implementation, if customer management server 120 determines that the selected campaign is active, campaign management server 120 may generate one or more rules (e.g., rules to be applied to a marketing campaign) based on one or more products and/or services. For example, campaign management server 120 may generate a rule that a certain product (e.g., a cell phone) should be offered with a certain service (e.g., a cell phone service plan) in the marketing campaign. Campaign management server 120 may create a search query (e.g., a query of terms associated with the marketing campaign) based on the one or more rules. In the cell phone/cell phone service example, campaign management server 120 may create a search query that searches for customers who may be interested in the cell phone/cell phone service offer.

Returning to FIG. 11, the search query may be executed against scored information (block 1140), and a call list and/or details associated with the call list may be matched with results of the search query (block 1150). For example, in one implementation, campaign management server 120 may execute the search query against scored information 450 (e.g., provided by score matrix logic 410) to generate search query results (e.g., a list of customers), and may match the search query results with a call list (e.g., customer lists 460) and/or call list details. In the cell phone/cell phone service example, campaign management server 120 may match the customers who may be interested in the cell phone/cell phone service offer with customers provided in a customer list and their associated customer details (e.g., names, telephone numbers, addresses, etc.).

As further shown in FIG. 11, the search query results, call list, and/or call list details may be stored (block 1160), and a customer list may be generated based on the search query results, call list, and/or call list details (block 1170). For example, in one implementation, campaign management server 120 may store the search query results (e.g., a list of customers), the call list, and the call list details in a database (e.g., provided in storage device 250), and may generate a customer list (e.g., customer lists 460) based on the stored search query results, call list, and call list details. The customer list may include a list of customers that may be targeted by campaign information 380.

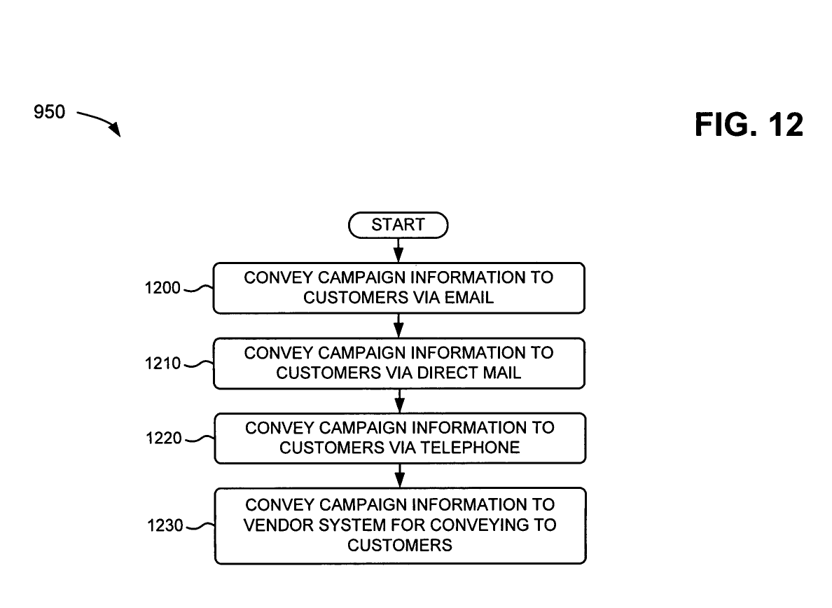

Process block 950 may include the process blocks illustrated in FIG. 12. As shown in FIG. 12, process block 950 may include conveying the campaign information to one or more customers via email (block 1200), conveying the campaign information to one or more customers via direct mail (block 1210), conveying the campaign information to one or more customers via a telephone (block 1220), or conveying the campaign information to a vendor system for conveying to one or more customers (block 1230). For example, in one implementation described above in connection with FIG. 3, campaign management server 120 may provide customer data 370 and/or campaign information 380 to user device 110, vendor system 340, and/or email system 350. User device 110 (e.g., with or without marketer 320) may convey campaign information 380 to customer 330. In one example, user device 110 may email campaign information 380 to customer 330. In another example, user device 110 may be used by marketer 320 to contact customer 330 and to convey campaign information 380 to marketer 320 while marketer 320 verbally interacts with customer 330 (e.g., a telemarketing arrangement). Vendor system 340 may convey campaign information 380 to one or more customers (e.g., customer 330) provided on the customer lists. In one example, vendor system 340 may include one or more devices associated with third party telemarketers that may access one or more marketing campaigns and/or customer lists for one or more products and/or one or more services (e.g., via vendor system 340), and may market (e.g., via telephones) the one or more products/services to one or more customers provided in the customer lists. Email system 350 may convey, via email, campaign information 380 to one or more customers (e.g., customer 330) provided on the customer lists.

Implementations described herein may include systems and/or methods that provide an end-to-end campaign management application for automatically managing, generating, saving, and/or executing a marketing campaign and/or a customer list for one or more products and/or one or more services. For example, in one implementation, the campaign management application may receive customer data, customer models, and/or customer reports, and may calculate scored information based on the received information. The campaign management application may generate product and/or service campaign information based on the scored information, and may generate a customer marketing list based on the campaign information and the received information. The campaign information may be conveyed by the campaign management application to customers on the customer list, and feedback may be received by the campaign management application from the customers about the campaign information. The campaign management application may update the customer data, customer models, and/or customer reports based on the received feedback.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 9-12, the order of the blocks may be modified in other implementations. Further, non-dependent acts may be performed in parallel.

Also, the term “user” has been used herein, and is intended to be broadly interpreted to include user device 110 or a user (e.g., marketing manager 310, marketer 320, etc.) of user device 110.

It will be apparent that embodiments, as described herein, may be implemented in many different forms of software, firmware, and hardware in the implementations illustrated in the figures. The actual software code or specialized control hardware used to implement embodiments described herein is not limiting of the invention. Thus, the operation and behavior of the embodiments were described without reference to the specific software code—it being understood that one would be able to design software and control hardware to implement the embodiments based on the description herein.

Further, certain portions of the invention may be implemented as “logic” that performs one or more functions. This logic may include hardware, such as an application specific integrated circuit or a field programmable gate array, software, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computing device-implemented method, comprising:
receiving one or more of customer data, customer models, or customer reports;
calculating scored information based on the one or more of the customer data, customer models, or customer reports;
generating marketing campaign information for a product or a service based on the scored information and the one or more of the customer data, customer models, or customer reports;
generating a customer list based on the marketing campaign information and the one or more of the customer data, customer models, or customer reports; and
conveying the marketing campaign information to one or more customers on the customer list.

2. The computing-device implemented method of claim 1, further comprising:
providing for display of the marketing campaign information to one or more of a marketer or a marketing manager.

3. The computing device-implemented method of claim 1, further comprising:
receiving feedback from the one or more customers; and
updating the one or more of the customer data, customer models, or customer reports based on the feedback.

4. The computing device-implemented method of claim 1, where generating marketing campaign information comprises:
providing for display of one or more marketing campaign properties;
receiving selection or input of the one or more marketing campaign properties;
creating a marketing campaign flow based on the selected or input one or more marketing campaign properties;
providing for display of the marketing campaign flow; and
generating the marketing campaign information based on the selected or input one or more marketing campaign properties and the marketing campaign flow.

5. The computing device-implemented method of claim 1, where generating a customer list comprises:
selecting a marketing campaign from a group of marketing campaigns;
generating one or more rules based on a product or service associated with the selected marketing campaign;
creating a search query based on the one or more rules;
executing the search query on the scored information;
matching a call list and details associated with the call list to search query results;
storing one or more of the search query results, the call list, or the details associated with the call list; and
generating the customer list based on the search query results, the call list, and the details associated with the call list.

6. The computing device-implemented method of claim 5, where selecting a marketing campaign comprises:
determining if a marketing campaign is active; and
selecting the marketing campaign if the marketing campaign is determined to be active.

7. The computing device-implemented method of claim 1, where conveying the marketing campaign information comprises one or more of:
conveying the marketing campaign information to the one or more customers via email;
conveying the marketing campaign information to the one or more customers via direct mail;
conveying the marketing campaign information to the one or more customers via telephone; or
conveying the marketing campaign information to the one or more customers to a vendor system for conveyance to the one or more customers.

8. A computer-readable memory device that stores computer-executable instructions, comprising:
one or more instructions for receiving one or more of customer data, customer models, or customer reports;
one or more instructions for calculating scored information based on the one or more of the customer data, customer models, or customer reports;
one or more instructions for generating marketing campaign information for a product or a service based on the scored information and the one or more of the customer data, customer models, or customer reports;
one or more instructions for generating a customer list based on the marketing campaign information and the one or more of the customer data, customer models, or customer reports;
one or more instructions for conveying the marketing campaign information to one or more customers on the customer list; and
one or more instructions for providing for display of the marketing campaign information to one or more of a marketer or a marketing manager.

9. The computer-readable memory device of claim 8, where the customer data comprises at least one of:
internal customer data associated with existing or potential customers; or
sourced customer data associated with existing or potential customers.

10. The computer-readable memory device of claim 8, where the customer models comprise at least one of:
a customer loyalty model;
a customer retention model; or
a customer attrition model.

11. The computer-readable memory device of claim 8, where the customer reports comprise at least one of:
a report that identifies valuable customers and how to treat them;
a report that identifies opportunities and tactics to increase customer retention; or
a report that identifies up-sell and cross-sell opportunities.

12. The computer-readable memory device of claim 8, where the score information comprises a dynamic score matrix that identifies one or more of customer segments, product attributes, service attributes, or customer churn information for an organization based on the one or more of the customer data, customer models, or customer reports.

13. The computer-readable memory device of claim 8, where the scored information identifies a group of similar customers such that a similar product or service may appeal to a majority of members of the group.

14. The computer-readable memory device of claim 8, where the marketing campaign information comprises one or more marketing campaigns for one or more products or one or more services.

15. The computer-readable memory device of claim 8, where the product comprises one or more of:
a radiotelephone;
a personal communications system (PCS) terminal;
a personal digital assistant (PDA);
a laptop;
a personal computer; or
a computation or communication device.

16. The computer-readable memory device of claim 8, where the service comprises one or more of:
a telephone service;
an Internet service;
a network service;
a radio service;
a television service; or
a video service.

17. The computer-readable memory device of claim 8, where each of the one or more customers comprises a person or a business entity capable of purchasing one or more products or one or more services.

18. The computer-readable memory device of claim 8, where the marketer comprises a person responsible for interacting with the one or more customers to market one or more products or one or more services.

19. The computer-readable memory device of claim 8, where the marketing manager comprises a person responsible for marketing one or more products or one or more services.

20. The computer-readable memory device of claim 8, further comprising:
one or more instructions for receiving feedback from the one or more customers; and
one or more instructions for updating the one or more of the customer data, customer models, or customer reports based on the feedback.

21. The computer-readable memory device of claim 8, further comprising:
one or more instructions for providing for display of one or more marketing campaign properties;
one or more instructions for receiving selection or input of the one or more marketing campaign properties;
one or more instructions for creating a marketing campaign flow based on the selected or input one or more marketing campaign properties;
one or more instructions for providing for display of the marketing campaign flow; and
one or more instructions for generating the marketing campaign information based on the selected or input one or more marketing campaign properties and the marketing campaign flow.

22. The computer-readable memory device of claim 8, further comprising:
one or more instructions for selecting a marketing campaign from a group of marketing campaigns;
one or more instructions for generating one or more rules based on a product or service associated with the selected marketing campaign;
one or more instructions for creating a search query based on the one or more rules;
one or more instructions for executing the search query on the scored information;
one or more instructions for matching a call list and details associated with the call list to search query results;
one or more instructions for storing one or more of the search query results, the call list, or the details associated with the call list; and
one or more instructions for generating the customer list based on the search query results, the call list, and the details associated with the call list.

23. The computer-readable memory device of claim 22, further comprising:
one or more instructions for determining if a marketing campaign is active; and
one or more instructions for selecting the marketing campaign if the marketing campaign is determined to be active.

24. The computer-readable memory device of claim 8, further comprising one or more of:
one or more instructions for conveying the marketing campaign information to the one or more customers via email;
one or more instructions for conveying the marketing campaign information to the one or more customers via direct mail;
one or more instructions for conveying the marketing campaign information to the one or more customers via telephone; or
one or more instructions for conveying the marketing campaign information to the one or more customers to a vendor system for conveyance to the one or more customers.

25. A system comprising:
means for receiving one or more of customer data, customer models, or customer reports;
means for calculating scored information based on the one or more of the customer data, customer models, or customer reports;
means for generating marketing campaign information for a product or a service based on the scored information and the one or more of the customer data, customer models, or customer reports;
means for generating a customer list based on the marketing campaign information and the one or more of the customer data, customer models, or customer reports;
means for conveying the marketing campaign information to one or more customers on the customer list;
means for providing for display of the marketing campaign information to one or more of a marketer or a marketing manager;
means for receiving feedback from the one or more customers; and
means for updating the one or more of the customer data, customer models, or customer reports based on the feedback.
